(19) United States
(12) Patent Application Publication
(10) Pub. No.: US 2006/0230019 A1
(43) Pub. Date: Oct. 12, 2006

(54) System and method to optimize database access by synchronizing state based on data access patterns

(75) Inventors: Justin Howard Hill, Durham, NC (US); Matt Richard Hogstrom, Cary, NC (US); Yang Lei, Cary, NC (US); Harry R. Nayak, Morgan Hill, CA (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/102,325

(22) Filed: Apr. 8, 2005

(51) Int. Cl. G06F 17/30

(52) U.S. Cl. 707/2

(57) ABSTRACT

A method, apparatus, and computer program product in a data processing system for avoiding excessive database round trips. A list of a database object fields affected by queries is compiled by analyzing instructions in a database query language. A list of database object fields affected by queries is also compiled by analyzing database object relationships. Using the combined list of affected database object fields, when a find operation is invoked, a determination is made as to whether the affected database object fields have been modified. Next, if the affected database object fields have been modified, database updates are generated for the affected database objects containing the affected database object fields. After that, the database updates are executed after all affected database object fields have been processed. Finally, the queries are submitted.

### BACKGROUND OF THE INVENTION

1. Technical Field

The present invention relates generally to an improved data processing system and, in particular, to a method, apparatus and computer program product for optimizing performance in a data processing system. Still more particularly, the present invention provides a system, method, apparatus, and computer program product for enhancing performance by avoiding excessive database round trips.

2. Description of Related Art

A bean is a component architecture for the Java programming language, developed initially by Sun, but now available from several other vendors. Java Beans allow developers to create reusable software components that can then be assembled together using visual application builder tools.

An entity bean represents a business object in a persistent storage mechanism, such as a relational database. Some examples of business objects are customers, orders, and products. Typically, each entity bean has an underlying table in a relational database, and each instance of the bean corresponds to a row in that table. Because the state of an entity bean is saved in a storage mechanism, it is persistent. Persistence means that the entity bean's state exists beyond the lifetime of the application or the server process.

Enterprise Java Beans (EJB) technology is the server-side component architecture for the Java 2 Platform, Enterprise Edition (J2EE) platform. EJB technology enables rapid and simplified development of distributed, transactional, secure and portable applications based on Java technology.

There are two types of persistence for entity beans: bean-managed and container-managed. With bean-managed persistence, the entity bean code that users write contains the calls that access the database. If a bean has container-managed persistence, the EJB container automatically generates the necessary database access calls. The code that users write for the entity bean does not include these calls.

A Container-Managed Persistence (CMP) bean is an entity bean whose state is synchronized with the database automatically. The bean developer does not need to write any explicit database calls into the bean code because the container automatically synchronizes the persistent fields with the database as dictated by the deployer at deployment time.

When a CMP bean is deployed, the deployer uses the EJB tools provided by the vendor to map the persistent fields in the bean to the database. The persistence fields are a subset of the instance fields, called container-managed fields, as identified by the bean developer in the deployment descriptor.

In the case of a relational database, for example, each persistent field is associated with a column in a table. A bean may map all its fields to one table or, in the case of more sophisticated EJB servers, to several tables. CMP are not limited to relational database. CMP beans can be mapped to object databases, files, and other data stores including legacy systems.

With CMP, the bean developer does not need to write any database access logic into the bean, but bean is notified by the container when its state is synchronized with the database. The container notifies the bean using the ejbLoad( ) and ejbstore( ) methods.

The ejbLoad( ) method alerts the bean that its container-managed fields have just been populated with data from the database. This gives the bean an opportunity to do any post processing before the data can be used by the business methods. The ejbStore( ) method alerts the bean that its data is about to be written to the database. This gives the bean an opportunity to do any pre-processing to the fields before they are written to the database.

In addition to these methods, the EJB Specification also describes a set of methods that are used to locate data and are typically referred to as Finder Methods. Finder Methods are responsible for creating a list of entities that match a query semantic specified in EJB Query Language (EJBQL). EJBQL is used to generate the SQL which is executed by the relational database system. The results of the query may or may not be correct if several entities have already been enlisted in the transaction and have been modified prior to the query being executed and not synchronized with the database.

Currently, the way that database queries insure correct results is through a procedure called “flush before find.” In this procedure, entities in memory are synchronized with the database by “flushing,” or storing, all modifications made to the entities into the relational database prior to the query's execution. The reason to “flush before find” is to ensure that the data store accurately reflects the state of all entities currently enlisted. This means that any of the entities which affect part of the result of a query need to be synchronized with the database. However, the synchronization with the database can be expensive as database roundtrip is always one of the most significant factors affecting an application's performance. By reducing the number of round trips to the database, the performance of the application is improved. It is most desirable to only flush the entities which affect the query to avoid unnecessary database activity.

Therefore, it would be advantageous to have an improved system, method, apparatus, and computer program product for avoiding unnecessary database activity.

### BRIEF SUMMARY OF THE INVENTION

The present invention provides a method, apparatus, and computer program product in a data processing system for avoiding excessive database round trips. A list of a database object fields affected by queries is compiled by analyzing instructions in a database query language. A list of database object fields affected by queries is also compiled by analyzing database object relationships. Using the combined list of affected database object fields, when a find operation is invoked, a determination is made as to whether the affected database object fields have been modified. Next, if the affected database object fields have been modified, database updates are generated for the affected database objects containing the affected database object fields. After that, the database updates are executed after all affected database object fields have been processed. Finally, the queries are submitted.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a block diagram of the interaction between components for the “flush before find” optimization according to a preferred embodiment of the present invention;

FIG. 4 is a flowchart of the process for the “flush before find” optimization according to a preferred embodiment of the present invention;

FIG. 5 is a block diagram of general examples for beans from step 402 and step 404 in FIG. 4, according to a preferred embodiment of the present invention; and

FIG. 6 is a block diagram of specific examples for beans from step 402, step 404, step 406, step 408, step 410, and step 412 in FIG. 4, according to a preferred embodiment of the present invention.

### DETAILED DESCRIPTION OF THE INVENTION

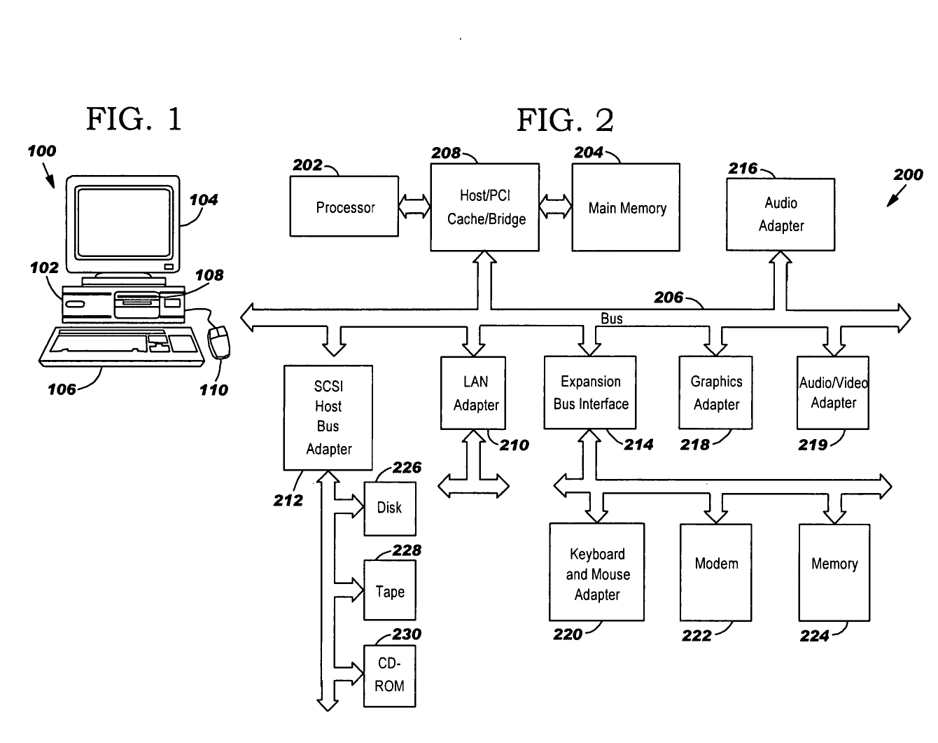

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

The present invention introduces a mechanism to optimize “flush before find” by evaluating the modified fields in enlisted entities and comparing these fields with those that affect the results of a query. Only the entities whose changed fields affect the results of the query are flushed.

The illustrated examples of the present invention are centered on J2EE Container Managed Persistence (CMP) Entity beans; however, the same optimization can be used by other object persistence systems. Currently, other J2EE vendors flush all modified entities to the database without regard to the impact on the query of the entity bean's changed fields.

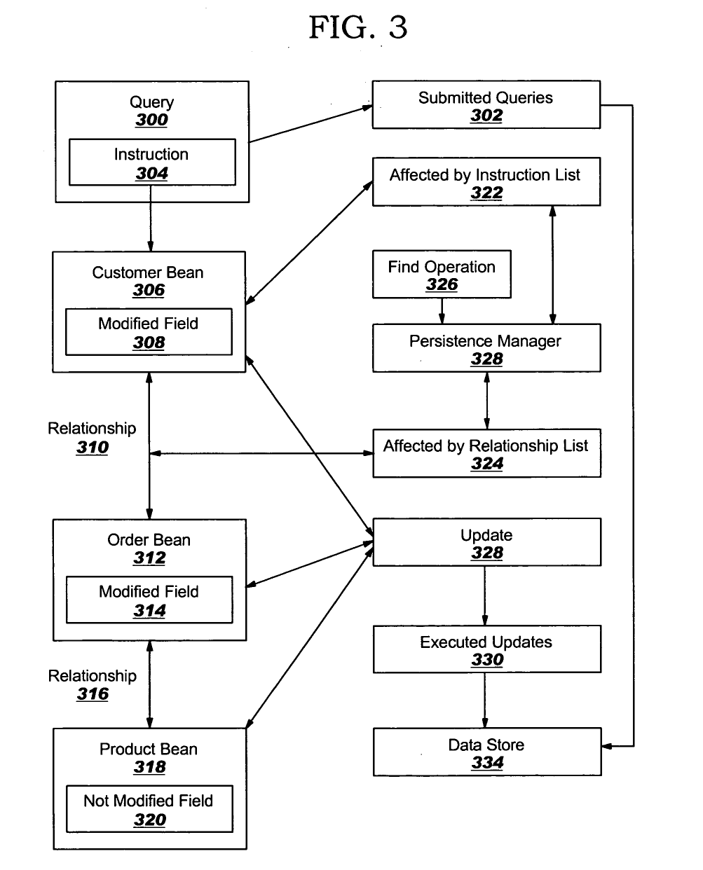

FIG. 3 is a block diagram of the interaction between components for the “flush before find” optimization according to a preferred embodiment of the present invention. Before Query 300 is submitted to Submitted Queries 302, Instruction 304 is analyzed to determine if the modifications in Customer Bean 306 will affect the results of Query 300. Relationship 310 between Customer Bean 306 and Order Bean 312 is also checked to determine if modifications in Order 312 will affect the results of Query 300. In addition to Relationship 310, Relationship 316 between Order Bean 312 and Product Bean 318 is also checked to determine if modifications in Product Bean 318 will affect the results of Query 300. If Modified Field 308 in Customer Bean 306 affects the results of Query 300, Affect by Instruction List 322 contains a reference to Modified Field 308. If Modified Field 314 in Order Bean 312 affects the results of Query 300, and this is due to Relationship 310 between Customer Bean 306 and Order Bean 312, then Affected by Relationship List 324 contains a reference to Relationship 310. If Not Modified Field 320 in Product Bean 318 affects the results of Query 300, and this is due to Relationship 316 between Order Bean 312 and Product Bean 318, then Affected by Relationship List 324 contains a reference to Relationship 316.

When Find Operation 326 is invoked, Persistence Manager 328 examines Affected by Instruction List 322 and Affected by Relationship List 324 to determine if Modified Field 308 in Customer Bean 306 has been modified and if Modified Field 314 in Order Bean 312 has been modified. If Modified Field 308 in Customer Bean 306 has been modified, if Modified Field 314 in Order Bean 312 has been modified, or if Not Modified Field 320 in Product Bean 318 has been modified, then Update 330 is generated for whatever bean has been modified, whether it is Customer Bean 306, Order Bean 312, or Product Bean 318. After Update 330 has been executed at Executed Updates 332, then Data Store 334 has the modifications from Customer Bean 306, Order Bean 312, and Product Bean 318 that affect Query 300. After Data Store 334 has been updated, then Query 300 is submitted to Submitted Queries 302, which can then query Data Store 334 without any synchronization problems.

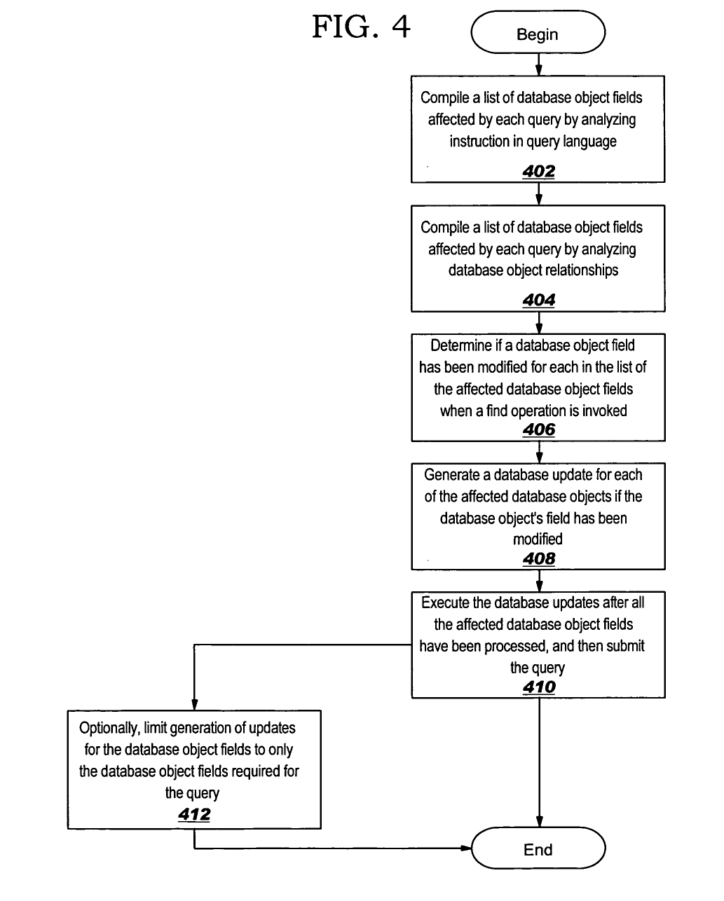

FIG. 4 is a flowchart of a process for the “flush before find” optimization according to a preferred embodiment of the present invention. To implement this “flush before find” optimization, the method analyzes what entity bean fields are needed by each query. This analysis is required even if only one query is to be executed, such that the set of queries analyzed comprises one or more queries. The bean fields needed are obtained in step 402 by analyzing instructions in Enterprise Java Bean Query Language (EJBQL), which is specified for all the customer defined finders, and in step 404 by analyzing Container Managed Relationship (CMR) definitions for Enterprise Java Bean (EJB) relationship navigation required finders. This analysis is required even if only one instruction is to be executed or only one relationship defined, such that the set of instructions analyzed comprises one or more instructions and the set of relationships defined comprises one or more relationships. The result of the analysis is a list of CMP/CMR fields that are part of the Where predicate of the generated SQL. This list is compiled even if only one field is part of the Where predicate of the generated SQL, such that the set of affected fields comprises one or more affected fields. This analysis of determining which entities are affected is accomplished at deployment time and stored for reference at runtime by the Persistence Manager.

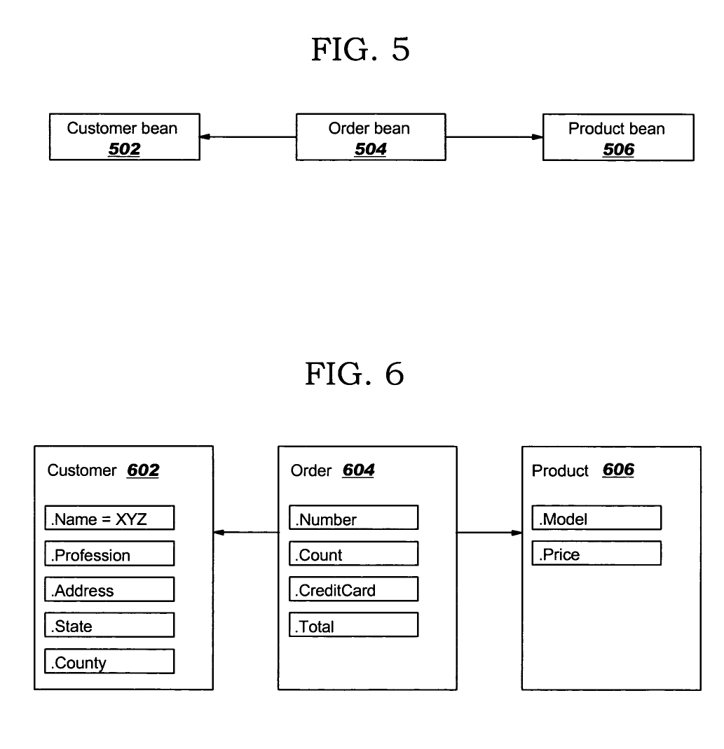

FIG. 5 is a diagram of general examples for beans from step 402 and step 404 in FIG. 4 according to a preferred embodiment of the present invention. For example, each Customer is represented by an instance of Customer bean 502 in FIG. 5, each Order is represented by an instance of an Order bean 504, and each Product is represented by an instance of Product bean 506. While an Order instance 504 is associated to one particular Customer 502, Product instance 506 may be associated with one Order 504 or multiple Orders (not depicted).

FIG. 6 is a diagram of specific examples for beans from step 402 and step 404 in FIG. 4 according to a preferred embodiment of the present invention. If a query is finding data Where Customer.Name=XYZ 602 in FIG. 6, in order to insure synchronization, all modified entities enlisted Where Customer.Name is changed have to be updated or flushed to the database before the query is executed. The effect is that only EJBQL instructions where Customer.Name is changed have to be analyzed to determine if the affected entity has been modified. If Customer.Name has not been modified for an affected entity, but other Customer fields have been modified for the affected entity, the affected entity will not need to be flushed. However, if Customer.Name has been modified for an affected entity, all of the modified fields for the affected entity are flushed to the database before the query is executed.

Additionally, some entities may have been modified that affect the query results Where Customer.Name=XYZ 602, even though the modified entities did not specify directly Where Customer.Name=XYZ 602. This could be the case if the EJBQL instructions specified Where Order.Customer.Name=XYZ and an instance of an Order 604 is associated to Customer.Name=XYZ 602. In this situation, in addition to checking the field of Customer.Name=XYZ 602, all modified entities enlisted where Order.Customer (because Order holds the Customer key in the database) is changed have to be updated or flushed to the database before the query is executed. These additional fields are determined by analyzing the CMR definition for the EJB relationship navigation finders. The effect is that Customer entities where Customer.Name has been changed and Order entities where Order.Customer has been changed need to have these fields checked for modification.

FIG. 4 continues with a diagram of the steps for the “flush before find” optimization according to a preferred embodiment of the present invention. When a find operation is invoked, the Persistence Manager extracts for examination the bean fields affected by each query from the list that resulted from the query needs analysis, as shown in step 406 from FIG. 4. There may be multiple bean types for each query if the application is deployed for read-ahead. Read-ahead is the ability to pre-fetch data based on defined relationships of the J2EE Entity beans. For each of the affected beans, the list of target fields for the Where is queried to determine if the affected bean has been modified, as shown in step 406. This determination is made even if only one field is affected or only one affected field is modified, such that the set of fields affected comprises one or more fields and the set of affected fields modified comprises one or more fields. If an affected field has been modified, an Update is generated to synchronize the state of the affected bean's fields with the database in step 408. This Update is generated for each of the modified affected beans even if only one affected field is modified in only one affected bean, such that the set of Updates comprises one or more Updates and the set of modified affected beans comprises one or more modified affected beans. Step 410 illustrates that when all the affected bean's fields have been processed, the updates are executed and then the waiting query is then submitted. This Update is executed and then the query submitted for each of the modified affected beans even if only one affected field is modified in only one affected bean, such that the set of Updates comprises one or more Updates and the set of queries comprises one or more queries.

FIG. 6 is also a diagram of specific examples for beans from step 406, step 408, and step 410 in FIG. 4 according to a preferred embodiment of the present invention. For example, in FIG. 6 a query is finding data Where Customer.Name=XYZ 602 and the query subsequently specifies Order 604 where Order.Customer is the Customer previously specified in the query. To insure synchronization, all modified entities enlisted Where Customer.Name is changed have to be updated or flushed to the database before the query is executed. Additionally, all modified entities enlisted Where Order.Customer is changed have to be updated or flushed to the database before the query is executed. The effect is that an Update is generated to synchronize the state of the modified Customer entities where Customer.Name has been changed and modified Order entities where Order.Customer has been changed with the database.

FIG. 4 continues with a diagram of an optional step for the “flush before find” optimization according to a preferred embodiment of the present invention. A further optimization is in step 412 in FIG. 4, limiting the field updates to only the required set for the query. This Update is generated for each of the modified affected beans fields even if only one affected field is modified in only one affected bean, such that the set of Updates comprises one or more Updates and the set of modified affected bean fields comprises one or more modified affected bean fields. As a consequence, a potentially smaller subset of updates is executed, further reducing the load on the database. All other updates could then be deferred until Transaction Commit time. Of course, the performance improvement of this further optimization depends on the transaction type being executed.

FIG. 6 is also a diagram of specific examples for beans from step 412 in FIG. 4 according to a preferred embodiment of the present invention. For example, in FIG. 6 a query is finding data Where Customer.Name=XYZ 602. If Customer.Name has not been modified for an affected entity, but other Customer fields have been modified for the affected entity, the affected entity will not need to be flushed. This affected entity could defer updating until Transaction Commit time. However, if Customer.Name has been modified for an affected entity, only Customer.Name for the affected entity, but no other modified fields for the affected entity, is flushed to the database before the query is executed. This optimization results in updates only for modified field that directly affects the query results, but no update for any of the other modified fields.

Therefore, the mechanism of the present invention, described above, avoids expensive database round trips by flushing only the entities which affect the query.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for avoiding excessive database round trips, the method comprising:
compiling a list of a set of database object fields affected by a set of queries by analyzing a set of instructions in a database query language;
compiling a list of a set of database object fields affected by a set of queries by analyzing a set of database object relationships;
determining if the set of database object fields has been modified from a combined list of the set of affected database object fields when a find operation is invoked;
generating a set of database updates for a set of affected database objects if any of the affected database object fields in the set of affected database objects has been modified;
executing the set of database updates after all the affected database object fields have been processed; and
submitting the set of queries after executing the set of database updates.

2. The method of claim 1, wherein the set of database object fields affected by the set of queries are in Container Managed Persistence entity beans and the set of instructions in the database query language analyzed are in Enterprise Java Bean Query Language.

3. The method of claim 1, wherein the set of database object fields affected by the set of queries are in Container Managed Persistence entity beans and the set of database object relationships analyzed are Container Managed Relationship definitions.

4. The method of claim 1, wherein a Persistence Manager determines if the set of database object fields has been modified when a find operation is invoked and the set of database object fields affected by the set of queries are in Container Managed Persistence entity beans.

5. The method of claim 1, wherein the method generates the set of database updates for a set of the affected database object fields instead of for the affected database objects if the set of the database object fields has been modified.

6. A data processing system for avoiding excessive database round trips, the data processing system comprising:
compiling means for compiling a list of a set of database object fields affected by a set of queries by analyzing a set of instructions in a database query language;
compiling means for compiling a list of a set of database object fields affected by a set of queries by analyzing a set of database object relationships;
determining means for determining if the set of database object fields has been modified from a combined list of a set of the affected database object fields when a find operation is invoked;
generating means for generating a set of database updates for a set of affected database objects if any of the affected database object fields in the set of affected database objects has been modified;
executing means for executing the set of database updates after all the affected database object fields have been processed; and
submitting means for submitting the set of queries after executing the set of database updates.

7. The data processing system of claim 6, wherein the set of database object fields affected by the set of queries are in Container Managed Persistence entity beans and the set of instructions in the database query language analyzed are in Enterprise Java Bean Query Language.

8. The data processing system of claim 6, wherein the set of database object fields affected by the set of queries are in Container Managed Persistence entity beans and the set of database object relationships analyzed are Container Managed Relationship definitions.

9. The data processing system of claim 6, wherein a Persistence Manager determines if the set of database object fields has been modified when a find operation is invoked and the set of database object fields affected by the set of queries are in Container Managed Persistence entity beans.

10. The data processing system of claim 6, wherein the generating means generates the set of database updates for a set of the affected database object fields instead of for the affected database objects if the set of the database object fields has been modified.

11. A computer program product on a computer-readable medium for use in a data processing system for avoiding excessive database round trips, the computer program product comprising:
first instructions for compiling a list of a set of database object fields affected by a set of queries by analyzing a set of instructions in a database query language;
second instructions for compiling a list of a set of database object fields affected by a set of queries by analyzing a set of database object relationships;
third instructions for determining if the set of database object fields has been modified from a combined list of a set of the affected database object fields when a find operation is invoked;
fourth instructions for generating a set of database updates for a set of affected database objects if any of the affected database object fields in the set of affected database objects has been modified;
fifth instructions for executing the set of database updates after all the affected database object fields have been processed; and
sixth instructions for submitting the set of queries after executing the set of database updates.

12. The computer program product of claim 11, wherein the set of database object fields affected by the set of queries are in Container Managed Persistence entity beans and the set of instructions in the database query language analyzed are in Enterprise Java Bean Query Language.

13. The computer program product of claim 11, wherein the set of database object fields affected by the set of queries are in Container Managed Persistence entity beans and the set of database object relationships analyzed are Container Managed Relationship definitions.

14. The computer program product of claim 11, wherein a Persistence Manager determines if the set of database object fields has been modified when a find operation is invoked and the set of database object fields affected by the set of queries are in Container Managed Persistence entity beans.

15. The computer program product of claim 11, wherein the fourth instructions generates the set of database updates for a set of the affected database object fields instead of for the affected database objects if the set of the database object fields has been modified.
